(19) United States
(12) Patent Application Publication
(10) Pub. No.: US 2015/0170670 A1
(43) Pub. Date: Jun. 18, 2015

(54) AUDIO SIGNAL PROCESSING APPARATUS

(71) Applicant: NXP B.V., Eindhoven (NL)

(72) Inventors: Joris Luyten, Begijnendijk (BE); Temujin Gautama, Boutersem (BE)

(21) Appl. No.: 14/558,127

(22) Filed: Dec. 2, 2014

(30) Foreign Application Priority Data
Dec. 5, 2013 (EP) 13195890.2

(51) Int. Cl. G10L 21/04

(52) U.S. Cl. CPC G10L 21/04

(57) ABSTRACT

An audio signal processing apparatus for time scaling audio signals, the apparatus comprising an input terminal, an output terminal, a criterion applier and a time scaler, the input terminal configured to receive an audio input signal comprising one or more frames, the criterion applier configured to apply a distortion criterion to the received frames of the audio input signal in order to generate a control signal representative of whether or not the received frames satisfy the distortion criterion, the distortion criterion associated with a time scaling operation of the time scaler, the time scaler configured to perform the time scaling operation on some or all of the received frames to produce corresponding time scaled frames, the output terminal configured to provide an audio output signal comprising the received frames or their corresponding time scaled frames in accordance with the control signal of the criterion applier.

The present disclosure relates to the field of audio signal processing, and in particular, to an audio signal processing apparatus for time scaling audio signals.

Time scaling can be considered as the process of changing the speed or duration of an audio signal. Several methods to address this classical audio research topic have been proposed, each with their advantages and disadvantages. There is described herein a relatively simple apparatus and associated method which can enable audio signals to be time scaled with a reduced number of audible artefacts.

According to a first aspect, there is provided an audio signal processing apparatus for time scaling audio signals, the apparatus comprising an input terminal, an output terminal, a criterion applier and a time scaler, wherein:
the input terminal configured is to receive an audio input signal comprising one or more frames,
the criterion applier is configured to apply a distortion criterion to the received frames of the audio input signal in order to generate a control signal representative of whether or not the received frames satisfy the distortion criterion, the distortion criterion associated with a time scaling operation of the time scaler, and
the time scaler is configured to perform the time scaling operation on some or all of the received frames to produce corresponding time scaled frames,
the output terminal is configured to provide an audio output signal comprising the received frames or their corresponding time scaled frames in accordance with the control signal of the criterion applier.

The present apparatus is able to produce a time scaled audio output signal with fewer audible artefacts than existing systems of comparable complexity because the only time scaled frames that form part of the audio output signal are those corresponding to frames of the audio input signal which satisfy the distortion criterion. Its low complexity renders it suitable for real-time applications on platforms with limited resources (for example, processing power and memory), such as digital signal processors.

The time scaler may comprise a time scaling block and a switching block. The time scaling block may be configured to perform the time scaling operation on all frames of the audio input signal. The switching block may be configured to receive the control signal from the criterion applier, and provide the received frames or their corresponding time scaled frames to the output terminal in accordance with the control signal.

The time scaler may comprise a time scaling block configured to: receive the control signal from the criterion applier; selectively perform the time scaling operation on the received frames of the audio input signal which satisfy the distortion criterion in accordance with the control signal; and provide the received frames, or their corresponding time scaled frames if the time scaling operation has been performed, to the output terminal.

The time scaling operation may be a synchronised overlap-add time scaling operation and the distortion criterion may be related to the periodicity of audio data in the received frames.

The criterion applier may comprise a segment computation block and a decision block. The segment computation block may be configured to determine a segment length for the received frames of the audio input signal. The segment computation block may be configured to calculate the dissimilarity between consecutive segments of the received frames based on the determined segment length. The decision block may be configured to determine whether or not the calculated dissimilarity is below a threshold and generate a corresponding control signal. Those frames having a calculated dissimilarity below the threshold may be considered to comprise sufficiently periodic audio data and thus satisfy the distortion criterion.

The segment computation block may be configured to determine the segment length using the second peak of an autocorrelation function and/or minimising (or reducing to an acceptably low level) the mean squared difference between segments. The segment computation block may be configured to determine the segment length by, for each of a plurality of different candidate segment lengths, determining the dissimilarity between consecutive segments in accordance with the distortion criteria. The segment computation block may then be configured to select one of the plurality of candidate segment lengths in accordance with the determined dissimilarity for each of the plurality of different candidate segment lengths. The segment computation block may be configured to calculate the dissimilarity between consecutive segments using the ratio between the second peak of an autocorrelation function and the peak at lag 0, and/or the mean-square-error between the consecutive segments.

The time scaling operation may be a phase vocoder time scaling operation and the distortion criterion may be related to the strength of the tonal components relative to the remaining signal energy.

The criterion applier may comprise a spectrum analyser block and a decision block. The spectrum analyser block may be configured to represent the audio data of the received frames as a spectrum of harmonically related tonal components and calculate the relative tonal component strength of said spectrum. The decision block may be configured to determine whether or not the calculated relative tonal component strength is above a threshold and generate a corresponding control signal. Those frames having a calculated relative tonal component strength above the threshold may be considered to satisfy the distortion criterion.

The spectrum analyser block may be configured to represent the audio data of the received frames as a spectrum of harmonically related tonal components by converting the audio data into the frequency domain using a Fourier transform.

The threshold may be based on one or more of a minimum required audio output quality, the number of time scaled frames already forming part of the audio output signal, and the calculated dissimilarity or relative tonal component strength associated with one or more preceding frames of the audio input signal.

The apparatus may further comprise a buffer and a framer module. The buffer may be configured to temporarily store each frame of the audio output signal. The framer module may be configured to form new frames of a uniform size using the frames which are temporarily stored in the buffer and provide the new frames to a constant rate output terminal. The threshold may be based on the current level of the buffer such that buffer overflow and underflow are avoided.

The criterion applier may be configured to sequentially apply the distortion criterion to each frame, or pairs of frames, of the audio input signal, and generate the corresponding control signal, before the subsequent frame of the audio input signal is received at the input terminal.

The time scaling operation may be configured to stretch and/or compress the received frames of the audio input signal.

The apparatus may be one or more of an electronic device, a portable electronic device, a mobile phone, a desktop computer, a laptop computer, a tablet computer, a radio, an mp3 player, and a module for any of the aforementioned devices.

According to a further aspect, there is provided a method for time scaling audio signals, the method comprising:
receiving an audio input signal comprising one or more frames;
applying a distortion criterion to the received frames of the audio input signal in order to generate a control signal representative of whether or not the received frames satisfy the distortion criterion, the distortion criterion associated with a time scaling operation;
performing the time scaling operation on some or all of the received frames to produce corresponding time scaled frames; and
providing an audio output signal comprising the received frames or their corresponding time scaled frames in accordance with the control signal.

The steps of any method disclosed herein do not have to be performed in the exact order disclosed, unless explicitly stated or understood by the skilled person.

Corresponding computer programs for implementing one or more steps of the methods disclosed herein are also within the scope of the present disclosure and are encompassed by one or more of the described example embodiments.

One or more of the computer programs may, when run on a computer, cause the computer to configure any apparatus, including a circuit, controller, or device disclosed herein or perform any method disclosed herein. One or more of the computer programs may be software implementations, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

One or more of the computer programs may be provided on a computer readable medium, which may be a physical computer readable medium such as a disc or a memory device, or may be embodied as a transient signal. Such a transient signal may be a network download, including an internet download.

A description is now given, by way of example only, with reference to the accompanying drawings, in which:—

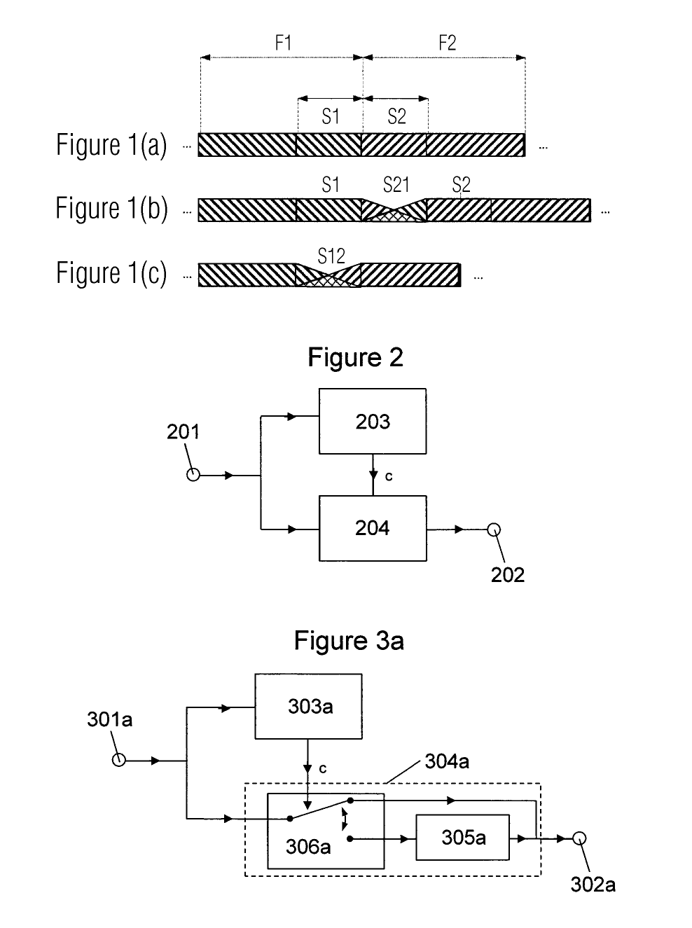

FIG. 1a illustrates schematically an example audio input signal;

FIG. 1b illustrates schematically an audio output signal produced by stretching the audio input signal of FIG. 1a using a synchronised overlap-add time scaling operation;

FIG. 1c illustrates schematically an audio output signal produced by compressing the audio input signal of FIG. 1a using a synchronised overlap-add time scaling operation;

FIG. 2 illustrates schematically an audio signal processing apparatus;

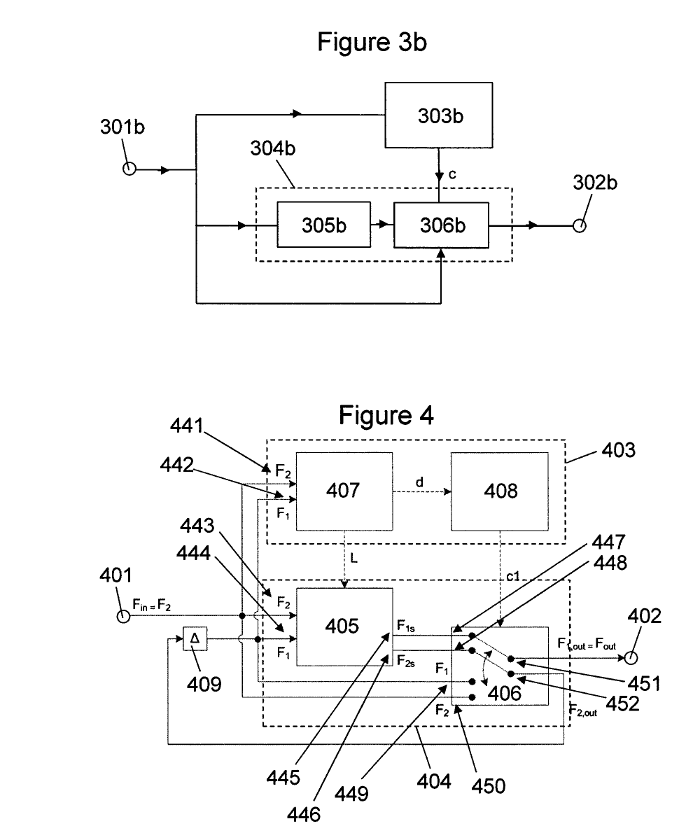

FIG. 3a illustrates schematically another audio signal processing apparatus;

FIG. 3b illustrates schematically another audio signal processing apparatus;

FIG. 4 illustrates schematically another audio signal processing apparatus;

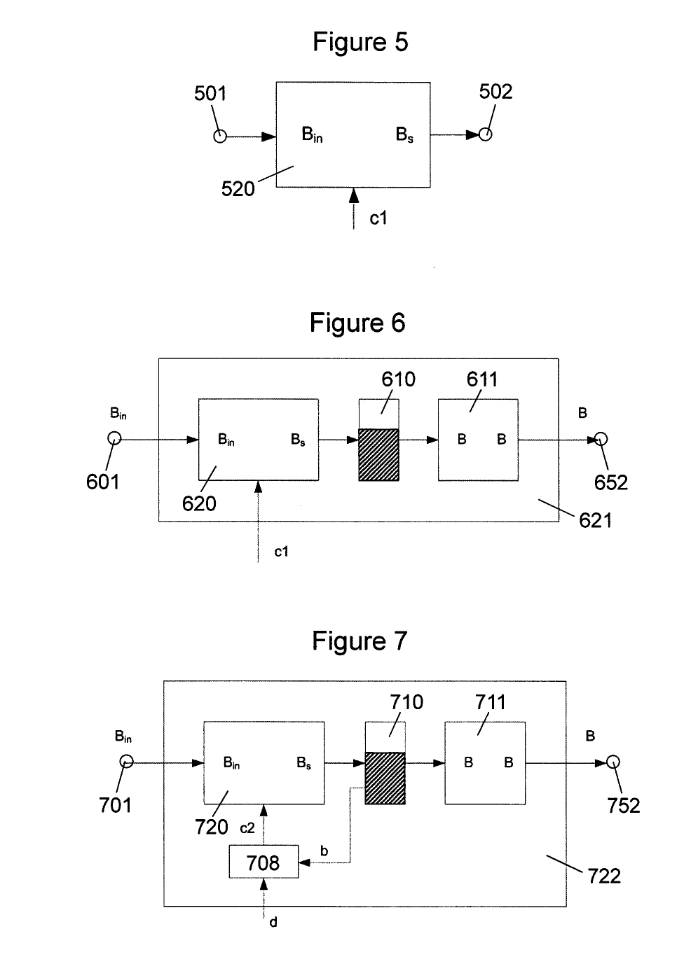

FIG. 5 illustrates schematically a variable rate time scaling block;

FIG. 6 illustrates schematically a constant rate time scaling block that includes the variable rate time scaling block of FIG. 5;

FIG. 7 illustrates schematically a further audio signal processing apparatus that includes the variable rate time scaling block of FIG. 5; and

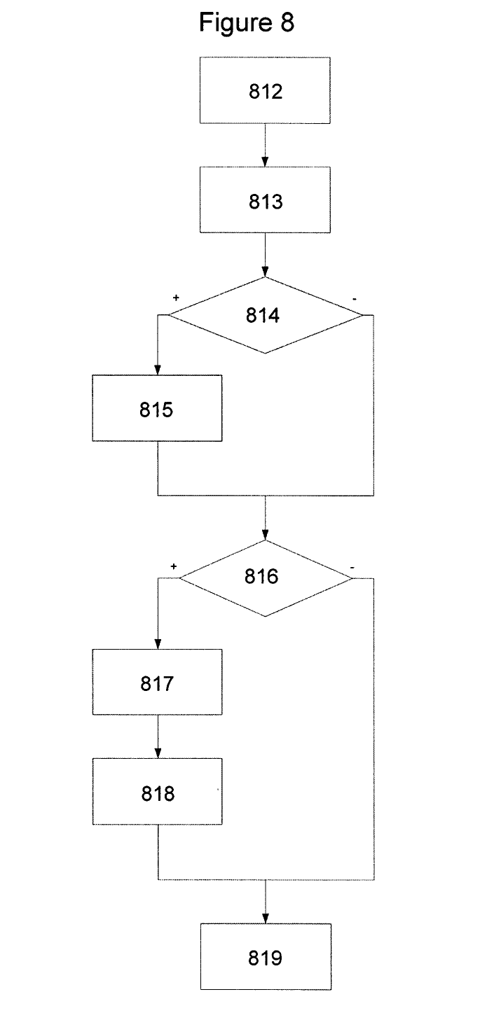

FIG. 8 illustrates schematically a method of time scaling audio signals.

As mentioned above, time scaling is the process of changing the speed or duration of an audio signal. The case where audio playback speed is reduced, and thus playback time increased, can be called time stretching or time expansion. The opposite process of decreasing the audio duration can be known as time compression.

Time scaling has many applications, including: synchronisation of multiple audio streams or audio with video (for example, film post-synchronisation); adjusting the duration of an audio clip (for example, radio commercial); matching the rhythm (beat) of audio tracks for disk-jockeying purposes; and speech processing (for example, more natural sounding text-to-speech synthesis).

Several approaches for time scaling have been proposed (see E. Moulines et al, Speech Communication, 16, 175 (1995) for example). These can be divided into three main categories: resampling, phase vocoder, and synchronised overlap-add.

The resampling technique adds or removes samples by resampling to a higher or lower sampling rate, but plays back the stream obtained at the original sample rate. It is a relatively simple approach, but changes the pitch of the audio signal which is considered to be unacceptable in most time scaling applications.

A phase vocoder can use a short term Fourier transform representation to model the signal as a combination of harmonically related sinusoids which are then time scaled by manipulating their phase. This technique enables high scaling rates, but can be more complex than resampling and overlap-add, and can also utilise an assumption that the signal can be modelled as a combination of sinusoids. However, this assumption is less restrictive than assumptions in relation to periodicity that may be used for overlap-add systems.

The synchronised overlap-add technique determines the period of a given section of the stream and, under the assumption of signal periodicity, adds or removes one or more periods using cross-fading. This is illustrated in FIGS. 1a-1c.

FIG. 1a illustrates schematically an audio input signal that is to be time scaled. The audio input signal comprises a number of frames (F1, F2). If we assume that the signal is periodic, then the frames (F1, F2) may be divided into a plurality of identical consecutive segments (S1, S2) each having a length equal to one period. Only one segment is shown in each frame for ease of illustration: the last segment S1 is shown in the first frame F1 and the first segment S2 is shown in the second frame F2. In this scenario, the audio input signal could be time scaled simply by inserting or removing a segment of the signal to produce a time stretched or time compressed audio output signal, respectively.

Since real-life signals tend not to be perfectly periodic, however, it is generally not possible to find identical consecutive segments. Nevertheless, if the segments are similar enough, insertion/removal of a segment may be possible with acceptably low distortion using synchronised overlap-add by inserting or removing a cross-fade between the segments, as discussed below with reference to FIGS. 1b and 1c.

FIG. 1 b illustrates schematically an audio output signal produced by stretching the audio input signal of FIG. 1a such that an additional segment S21 is inserted between segment S1 and segment S2. The additional segment S21 starts with information from segment S2, which then fades out while information from segment S1 fades in. In this scenario, the beginning of the cross-fade segment S21 looks like the beginning of segment S2 which ensures a continuous transition from the end of segment S1 because this transition was also present in the audio input signal. Likewise, the end of the cross-fade segment S21 looks like the end of segment S1, which allows for a smooth transition to the beginning of segment S2. As can be seen from this figure, the audio data of frame F2 has been changed following the stretching operation whilst the audio data of frame F1 remains unchanged.

FIG. 1c illustrates schematically an audio output signal produced by compressing the audio input signal of FIG. 1a such that a segment is removed by combining the last segment S1 from the first frame F1 with the first segment S2 from the second frame F2. This combined segment S12 starts with information from segment S1, which then fades out while information from segment S2 fades in. This produces “safe” transitions from the remaining part of frame F1 to the beginning of the cross-fade segment S12, and from the end of the cross-fade segment S12 to the remaining part of frame F2, because the audio output signal mimics the audio input signal. As can be seen from this figure, the audio data of both frames F1 and F2 has been changed following the compression operation.

Having a good strategy for identifying segment pairs S1 and S2 can be important for audio time scaling using the synchronised overlap-add approach, as this can enable a required scaling rate to be obtained while minimising/reducing audio artefacts.

Although the complexity of overlap-add is relatively low, its success can depend on the periodicity of the signal and a correct estimation of the period, and can therefore be less suitable for higher order scaling rates, especially with polyphonic music.

Audio signal processing systems can be used to carry out time scaling operations on each and every input frame. Therefore, when synchronised overlap-add or a phase vocoder are used, the time scaling operation can be performed regardless of whether or not the frames comprise periodic or sinusoidal audio data, respectively. As a result, more audible artefacts are present in the audio output signal when there is no or only mild periodicity or spectral peakiness in the audio input signal.

There will now be described an apparatus and associated methods which may address this issue. Although the following examples are directed towards synchronised overlap-add and the use of a phase vocoder, it will be appreciated that the principles described herein may be used with any time scaling techniques.

Later examples depicted in the figures have been provided with reference numerals that correspond to similar features of earlier described examples. For example, feature number 201 can also correspond to numbers 301, 401, 501 etc. These numbered features may appear in the figures but may not be directly referred to within the description of these particular examples. This has been done to aid understanding, particularly in relation to the features of similar earlier described examples.

FIG. 2 illustrates schematically an audio signal processing apparatus for time scaling audio signals comprising an input terminal 201, an output terminal 202, a criterion applier 203 and a time scaler 204. The apparatus may be one or more of an electronic device, a portable electronic device, a mobile phone, a desktop computer, a laptop computer, a tablet computer, a radio, an mp3 player, and a module for any of the aforementioned devices.

The input terminal 201 is configured to receive an audio input signal comprising one or more frames. The criterion applier 203 is configured to apply a distortion criterion to the received frames of the audio input signal in order to generate a control signal c representative of whether or not the received frames satisfy the distortion criterion. The distortion criterion is associated with a time scaling operation of the time scaler 204, and is used to distinguish between frames which would become undesirably distorted if they were subjected to the time scaling operation and those which would not. The time scaler 204 itself is configured to perform the time scaling operation (stretching and/or compression) on some or all of the received frames to produce corresponding time scaled frames.

The output terminal 202 is configured to provide an audio output signal comprising the received frames or their corresponding time scaled frames in accordance with the control signal of the criterion applier 203. The time scaled frames of the audio output signal correspond to the received frames of the audio input signal which satisfy the distortion criterion. In this way, the only time scaled frames that form part of the audio output signal are those that correspond to frames of the audio input signal which satisfy the distortion criterion, which can result in audio input signals being time scaled with fewer audible artefacts in the resulting output signal than those produced using existing systems of comparable complexity. This functionality could be useful for switching between analogue and digital signals in radio chips, for example.

FIG. 3a shows another audio signalling apparatus including a time scaler 304a. In this example, the time scaler 304a is configured to: receive the control signal from the criterion applier 303a; selectively perform the time scaling operation on the received frames of the audio input signal which satisfy the distortion criterion in accordance with the control signal c; and provide the received frames, or their corresponding time scaled frames if the time scaling operation has been performed, to the output terminal 302a.

In this example, the functionality of selectively performing the time scaling operation is provided by a switching block 306a. The switching block 306a has one switching input terminal that is connected to the input terminal 301a in order to receive the audio input signal. The switching block 306a also has a first switching output terminal that is connected to an input of a time scaling block 305a, and a second switching output terminal that is connected to the output terminal 302a. The output of the time scaling block 305a is also connected to the output terminal 302a. The position of the switch is set in accordance with the control signal c. In this way, the time scaler 304a can selectively bypass the time scaling functionality such that the time scaling operations are only performed on received frames that satisfy the distortion criterion. The control signal c from the criterion applier 303a is used to control whether or not the time scaling block 305a performs a time scaling operation. It will be appreciated that FIG. 3a represents a simplified representation of the apparatus and that in practice one or more buffers may be required in order to provide a continuous output signal that is properly time-aligned.

Rather than using the switching block 306a shown in FIG. 3a, the time scaling block 305a could be configured to selectively perform the time scaling operation on received frames of the audio input signal which satisfy the distortion criterion in accordance with the control signal c. This could be implemented with software, for example. In this scenario, the time scaling block 305a would be configured to receive the control signal c from the criterion applier.

FIG. 3b shows another audio signalling apparatus with a different time scaler 304b. In this example, the time scaler 304b comprises a time scaling block 305b and a switching block 306b. In this scenario, the time scaling block 305b is configured to perform the time scaling operation on all frames of the audio input signal, whilst the switching block 306b is configured to receive the control signal c from the criterion applier 303b, and provide the received frames or their corresponding time scaled frames to the output terminal 302b in accordance with the control signal.

In both the example of FIG. 3a and the example of FIG. 3b, therefore, the only time scaled frames that form part of the audio output signal are those that correspond to frames of the audio input signal which satisfy the distortion criterion. In this example, the control signal c from the criterion applier is used to control whether or not time scaled frames are provided to the output terminal.

FIG. 4 shows an apparatus that is configured to perform synchronised overlap-add time scaling. The input terminal 401 sequentially receives a plurality of frames as an audio input signal. The first frame received at the input terminal 401 is F1, the second frame is F2, etc. The signals in FIG. 4 are labelled as if the first frame F1 has already been received and processed and the second frame F2 is currently being received. That is Fᵢₙ=F2.

The apparatus of FIG. 4 includes a criterion applier 403, which comprises a segment computation block 407 (which may be referred to as an overlap-add segment computation block) and a decision block 408 (which may be referred to as an overlap-add decision block). The apparatus of FIG. 4 also includes a time scaler 404, which comprises a time scaling block 405 (which may be referred to as an overlap-add block) and a switching block 406 (which may be referred to as an overlap-add switch).

The input terminal 401 is connected to a current frame input terminal 441 of the segment computation block 407. The segment computation block 407 also has a previous frame input terminal 442, which receives a previous frame (either time-scaled or un-time scaled) from a delay buffer 409 as will be described below.

The segment computation block 407 is configured to process a current frame received at the current frame input terminal 441 and a previous frame received at the previous frame input terminal 442 in order to determine a segment length L for the received frames of the audio input signal based on the periodicity of the frames. The determined segment length L is provided as a control signal to the time scaling block 405.

In this example, the segment computation block 407 determines the segment length L by dividing the received frames into a plurality of data segments which are as large and as similar as possible. This may be achieved using the second peak of an autocorrelation function and/or the mean squared difference between segments. For example, the determined segment length may have the lowest, or an acceptably low, mean squared difference. The segment length L corresponds to the number of data samples that will be added/removed by the time scaling block 405 per overlap-add operation. The more samples that are added/removed per overlap-add operation, the fewer overlap-add operations are required per unit time. This can enable the apparatus to be operated in such a way that it can be more selective with respect to the quality of a match that is deemed sufficient. For example, a threshold may be automatically adjusted such that a particularly high quality audio output signal can be provided. In some examples however, the maximum segment length that can be processed may be limited by the platform on which the time scaling is implemented (for example, due to limited available processing power or memory).

The segment computation block 407 applies a plurality of different candidate segment lengths to data received as part of the received audio input signal in order to be able to determine which of the candidate segment lengths should be selected and passed to the time scaling block 405 as segment length L. The segment computation block 407 is configured to determine, for each of the plurality of different candidate segment lengths, the degree of dissimilarity between consecutive segments in accordance with the distortion criteria. The segment computation block 407 then selects one of the plurality of candidate segment lengths in accordance with the determined degree of dissimilarity for each of the plurality of different candidate segment lengths. For example, the segment computation block 407 may be configured to select the one of the plurality of different candidate segment lengths that has the lowest degree of dissimilarity. Alternatively, it may be configured to select one of the different candidate segment lengths that has a degree of dissimilarity below a segment-length-selection-threshold level, for example the longest candidate segment length that has a dissimilarity below the segment-length-selection-threshold level. In this respect, the segment computation block 407 may be configured to consider all possible segment lengths which are suitable for use in the synchronised overlap-add time scaling operation, and then select a segment length L according to the distortion criterion. The selected segment length L may be considered as the optimal segment length.

The segment computation block 407 is also configured to process the current frame received at the current frame input terminal 441 and the previous frame received at the previous frame input terminal 442 in order to calculate a degree of dissimilarity d between segments in the two received frames based on the determined segment length L. The dissimilarity between consecutive segments may be calculated using the ratio between the second peak of an autocorrelation function and the peak at lag 0, and/or the mean-square-error between the consecutive segments. The similarity between segments is a measure of the degree of periodicity of the audio data. The determined degree of dissimilarity d is provided as a control signal to the decision block 408. Computation of the segment length L and the degree of dissimilarity d may or may not be performed as separate steps. For example, when the segment length is determined by using the mean squared difference between consecutive segments, the dissimilarity between these segments may be determined as part of the calculation.

The decision block 408 is configured to compare the degree of dissimilarity d with a threshold and generate a corresponding control signal c1 for the switching block 406. A degree of dissimilarity d that is less than the threshold is considered to be sufficiently periodic and thus satisfy the distortion criterion. Similarly, a degree of dissimilarity d that is greater than the threshold is considered to be not sufficiently periodic and thus not satisfy the distortion criterion. In this way, the decision block 408 applies a distortion criterion that relates to the received frames comprising sufficiently periodic audio data. As will be described below, the control signal c1 will be used by the switching block 406 to control whether or not time-scaled frames or non-time-scaled frames are passed to the output terminal 402.

Turning now to the time scaler 404 of FIG. 4, the input terminal 401 is connected to a current frame input terminal 443 of the time scaling block 405. The time scaling block 405 also has a previous frame input terminal 444, which receives a previous frame (either time-scaled or un-time scaled) from a delay buffer 409 as will be described below.

The time scaling block 405 performs a time scaling operation, in this example an overlap-add time scaling operation, on the frames received at its current frame input terminal 443 and its previous frame input terminal 444 using the optimal segment length L received from the segment computation block 407. In this way, the time scaling block 405 produces a time scaled current frame F₂ₛ at a current frame output terminal 446 and produces a time scaled previous frame F₁ₛ at a previous frame output terminal 445.

The switching block 406 has four input terminals and two output terminals. The input terminals are: a previous frame time scaled input terminal 447; a current frame time scaled input terminal 448; a previous frame input terminal 449; and a current frame input terminal 450. The output terminals are a previous frame output terminal 451 and a current frame output terminal 452. When the control signal c1 received from the decision block 408 is representative of the distortion criterion being satisfied, the switching block 406 is configured to: connect the previous frame time scaled input terminal 447 to the previous frame output terminal 451; and to connect the current frame time scaled input terminal 448 to the current frame output terminal 452. When the control signal c1 received from the decision block 408 is indicative of the distortion criterion not being satisfied, the switching block 406 is configured to: connect the previous frame input terminal 449 to the previous frame output terminal 451; and connect the current frame input terminal 450 to the 452 current frame output terminal.

The previous frame output terminal 451 of the switching block 406 is connected to the output terminal 402 of the apparatus in order to provide the audio output signal.

The current frame output terminal 452 of the switching block 406 is connected to an input of a delay buffer 409. In this example, the delay buffer 409 applies a time delay that corresponds to a single frame of the received audio input signal such that consecutive frames are processed by the segment computation block 407 and the time scaling block 405. In other examples, the delay buffer 409 can apply a different time delay in order for the segment computation block 407 and the time scaling block 405 to process segments within a single frame, for example. The output of the delay buffer 409 provides the input signalling to: the previous frame input terminal 442 of the segment computation block 407; the previous frame input terminal 444 of the time scaling block 405; and the previous frame input terminal 449 of the switching block 406.

In comparison with audio output signals produced using existing overlap-add based systems of comparable complexity, the time scaled frames presented to the output terminal 402 advantageously comprise fewer audible artefacts, the total number of overlap-added segments is typically fewer, the distance between the overlap-added segments (which is inversely proportional to the scaling rate) is variable, and the average size of the overlap-added segments is typically greater.

The present apparatus can also be used with time scaling techniques other than synchronised overlap-add. For example, in another example, the apparatus is configured for phase vocoder time scaling. In this example (not shown), the segment computation block of FIG. 4 is replaced by a spectrum analyser block, and the distortion criterion relates to the received frames containing a sufficient amount of harmonic content/tonal components.

Such a spectrum analyser block can be configured to represent the audio data of the received frames as a spectrum of harmonically related tonal components in the frequency domain and calculate the relative strength of the tonal components of said spectrum. The audio data of the received frames may be represented as a spectrum of harmonically related tonal components by converting the audio data into the frequency domain using a Fourier transform. The relative strength of the tonal components may be calculated by measuring the energy associated with the peaks in the spectrum, measuring the average energy contained in the other frequency components, and comparing the two. For example, by determining the proportion of energy that is represented by the peaks in the spectrum.

The decision block can then be configured to determine whether or not the calculated relative tonal component strength is above a threshold and generate a corresponding control signal, wherein those frames having a calculated relative tonal component strength above the threshold are considered to satisfy the distortion criterion.

Depending on the decision made by the decision block, frames would be sent to the output either unprocessed or time scaled by the phase vocoder (for example, by time scaling the tonal components by manipulating their phase).

Aside from the above-mentioned differences relating to the underlying time scaling technique, the general functionality and concept of the phase vocoder example can be the same as the overlap-add example and will therefore not be described further.

The decision of whether or not to perform the time scaling operation (or whether or not to output the time scaled frames) may be made for each frame of the audio input signal. For real-time applications, this decision should be made before the next frame is processed and without any knowledge of the subsequent frames of the signal. In this respect, the criterion applier may be configured to sequentially apply the distortion criterion to each frame, or pairs of frames, of the audio input signal, and generate the corresponding control signal, before the subsequent frame of the audio input signal is received at the input terminal.

The threshold which is used by the decision block of the criterion applier to determine whether or not the frames of the audio input signal satisfy the distortion criterion may be predefined and fixed during processing of the audio input signal. In this scenario, the threshold may be used to set a minimum required audio output quality. Alternatively, the threshold may be varied from frame to frame in order to achieve a particular scaling factor. For example, the audio signal processing apparatus may comprise a threshold setting block (not shown) which is configured to set/vary the threshold based on the number of time scaled frames already forming part of the audio output signal and/or the calculated dissimilarity (for overlap-add) or spectral peakiness (for phase vocoder) associated with one or more preceding frames of the audio input signal.

It will be appreciated from the above description that a scaling factor applied by one or more of the apparatus disclosed herein is not necessarily the same for every frame. This is because only some frames of the audio input signal will be time scaled and used in the audio output signal. Furthermore, when the synchronised overlap-add time scaling operation is used, the optimal segment length calculated for one frame may not be the same as the optimal segment length calculated for another frame. As a result, the size of the frames forming the audio output signal (and hence the number of samples associated with these frames) may vary for input frames of a fixed size and number of samples. This is referred to as variable-rate time scaling, and can be undesirable for some real-time applications.

FIG. 5 illustrates schematically a variable rate time scaling block 520, which is an example of a time scaler such as those described above. The variable rate time scaling block 520 has an input terminal 501 and an output terminal 502, and also receives a control signal c1. When the variable rate time scaling block 520 is configured for synchronised overlap-add, frames of size Bᵢₙ are received at the input terminal 501, and frames of size Bₛ are provided at the output terminal 502, where

Bᵢₙ≦Bₛ≦2Bᵢₙ(stretching) Equation 1

0≦Bₛ≦Bᵢₙ(compression) Equation 2

The upper and lower limits of Bₛ follow from the assumption that Bᵢₙ is used as the maximum overlap-add segment length.

FIG. 6 shows a constant rate time scaling block 621 that includes a variable rate time scaling block 620 such as the one shown in FIG. 5. The constant rate time scaling block 621 also includes a buffer 610 and a framer module 611 (which may simply be referred to as a framer).

The buffer 610 has a buffer input terminal that is connected to the output terminal of the variable rate time scaling block 620. The buffer 610 also has a buffer output terminal that provides an output signal to the framer module 611. The buffer 610 is configured to temporarily store the frames of audio data which are output from the variable rate time scaling block 620 and make them available for the framer module 611. The framer module 611 is configured to form new frames of a uniform size using the data received from the output terminal of the buffer 610. These new frames are then provided to a constant rate output terminal 652 of the constant rate time scaling block 621. As illustrated schematically, the constant rate time scaling block 621 receives frames of fixed size Bᵢₙ at the input terminal 601 and outputs frames of fixed size B at the constant rate output terminal 652, where Bᵢₙ is related to B by:

Bᵢₙ=(1−r)B(stretching) Equation 3

Bᵢₙ=(1+r)B(compression) Equation 4

in which r is the scaling factor and has a value between 0 and 1. This is referred to as constant-rate time scaling.

In some examples, it can be advantageous for the buffer 610 to be half-full or nearly half-full at all times during the time scaling process to reduce the likelihood of buffer underflow or overflow. Buffer underflow occurs when data is being delivered to the buffer 610 at a lower rate than it is being read from the buffer 610, and can result in processing delays at the output end. In contrast, buffer overflow occurs when data is being delivered to the buffer 610 at a higher rate than it is being read from the buffer 610, and can result in previously stored data being overwritten by new data.

In order to maintain a constant buffer level, the present apparatus may be configured to vary the number of input frames which are stretched or compressed. This may be achieved by adjusting the threshold, which is used to determine whether or not the frames of the audio input signal satisfy the distortion criterion, based on the current level of data in the buffer 610.

FIG. 7 shows a constant rate time scaling block 722 that includes all of the components of FIG. 6 as well as a decision block 708 (which may be referred to as an overlap-add decision block). In this example, the buffer 710 is configured to provide a buffer signal b representative of the amount of data in the buffer 710. The buffer signal b is provided as an input to the decision block 708. The decision block 708 also receives a degree of dissimilarity d signal, such as the corresponding signal described above with reference to FIG. 4. The decision block 708 in this example is configured to set the value of a threshold that will be applied to the received degree of dissimilarity d signal to determine whether or not to provide time scaled frames at the output terminal. For example, if the buffer signal b is representative of the buffer being more than half-full, then the decision block 708 may automatically lower the threshold such that fewer frames are time scaled, and vice versa. In this way, the new threshold level influences whether or not the input frames satisfy the distortion criterion and therefore the control signal c2 that is provided to the variable rate time scaling block 720 is adjusted accordingly. This control of the threshold level results in a relative increase or decrease in the amount of data stored in the buffer 710 such that an output signal with a constant frame rate can be provided with a particularly high quality.

An overlap-add time scaling method according to one example of the present disclosure is shown schematically in FIG. 8. Steps 812-815 in the upper part of the flow chart relate to a variable-rate time scaling process whilst steps 816-819 in the lower part relate to the subsequent transformation into a constant-rate time scaling process.

The upper part of the method comprises determining 812 a segment length for one or more received frames of the audio input signal, and calculating 813 a degree of dissimilarity between consecutive segments of the received frames based on the determined segment length. Once the degree of dissimilarity has been calculated, it is compared 814 with a threshold to generate a corresponding control signal. When the dissimilarity is determined to be below the threshold, the control signal indicates that the received frames satisfy a distortion criterion associated with a synchronised overlap-add time scaling operation, and causes the time scaling operation to be performed 815 on these frames. When the dissimilarity is determined to be equal to or greater than the threshold, the control signal indicates that the received frames do not satisfy the distortion criterion, and prevents these frames from being time scaled.

If constant rate scaling is not required, the received frames, or their corresponding time scaled frames produced by the overlap-add time scaling operation, are output 819 for use in forming an audio output signal. If, however, constant rate scaling is required, the audio data of the received or time scaled frames is temporarily stored 817 in a buffer and used to form 818 new frames of a uniform size. These new frames are then output 819 for use in forming an audio output signal.

It will be appreciated that any components that are described herein as being coupled or connected could be directly or indirectly coupled or connected. That is, one or more components could be located between two components that are said to be coupled or connected whilst still enabling the required functionality to be achieved.

1. An audio signal processing apparatus for time scaling audio signals, the apparatus comprising an input terminal, an output terminal, a criterion applier and a time scaler, wherein
the input terminal is configured to receive an audio input signal comprising one or more frames,
the criterion applier is configured to apply a distortion criterion to the received frames of the audio input signal in order to generate a control signal representative of whether or not the received frames satisfy the distortion criterion, the distortion criterion associated with a time scaling operation of the time scaler,
the time scaler is configured to perform the time scaling operation on some or all of the received frames to produce corresponding time scaled frames, and
the output terminal is configured to provide an audio output signal comprising the received frames or their corresponding time scaled frames in accordance with the control signal of the criterion applier.

2. The apparatus of claim 1, wherein the time scaler comprises a time scaling block configured to:
receive the control signal from the criterion applier;
selectively perform the time scaling operation on the received frames of the audio input signal which satisfy the distortion criterion in accordance with the control signal; and
provide the received frames, or their corresponding time scaled frames if the time scaling operation has been performed, to the output terminal.

3. The apparatus of claim 1, wherein the time scaler comprises a time scaling block and a switching block,
the time scaling block configured to perform the time scaling operation on all frames of the audio input signal,
the switching block configured to receive the control signal from the criterion applier, and provide the received frames or their corresponding time scaled frames to the output terminal in accordance with the control signal.

4. The apparatus of claim 1, wherein the time scaling operation is a synchronised overlap-add time scaling operation and the distortion criterion is related to the periodicity of audio data in the received frames.

5. The apparatus of claim 4, wherein the criterion applier comprises a segment computation block and a decision block,
the segment computation block configured to determine a segment length for the received frames of the audio input signal, and calculate the dissimilarity between consecutive segments of the received frames based on the determined segment length,
the decision block configured to determine whether or not the calculated dissimilarity is below a threshold and generate a corresponding control signal, wherein those frames having a calculated dissimilarity below the threshold are considered to satisfy the distortion criterion.

6. The apparatus of claim 5, wherein the segment computation block is configured to determine the segment length by:
for each of a plurality of different candidate segment lengths, determining the dissimilarity between consecutive segments in accordance with the distortion criteria; and
selecting one of the plurality of candidate segment lengths in accordance with the determined dissimilarity for the plurality of different candidate segment lengths.

7. The apparatus of claim 1, wherein the time scaling operation is a phase vocoder time scaling operation and the distortion criterion is related to the strength of the tonal components relative to the remaining signal energy.

8. The apparatus of claim 7, wherein the criterion applier comprises a spectrum analyser block and a decision block,
the spectrum analyser block configured to represent the audio data of the received frames as a spectrum of harmonically related tonal components and calculate the relative strength of the tonal components of said spectrum,
the decision block configured to determine whether or not the calculated relative tonal component strength is above a threshold and generate a corresponding control signal, wherein those frames having a calculated relative tonal component strength above the threshold are considered to satisfy the distortion criterion.

9. The apparatus of claim 5, further comprising a threshold setting block configured to set the threshold in accordance with one or more of: a minimum required audio output quality, the number of time scaled frames already forming part of the audio output signal, and the calculated dissimilarity or relative tonal component strength associated with one or more preceding frames of the audio input signal.

10. The apparatus of claim 1, wherein the apparatus further comprises a buffer and a framer module, wherein
the buffer is configured to temporarily store each frame of the audio output signal, and
the framer module is configured to form new frames of a uniform size using the frames which are temporarily stored in the buffer and provide the new frames to a constant rate output terminal.

11. The apparatus of claim 10, further comprising a threshold setting block configured to set the threshold in accordance with a current level of data in the buffer such that buffer overflow and underflow are avoided.

12. The apparatus of claim 1, wherein the criterion applier is configured to sequentially apply the distortion criterion to each frame, or pairs of frames, of the audio input signal, and generate the corresponding control signal, before the subsequent frame of the audio input signal is received at the input terminal.

13. The apparatus of claim 1, wherein the time scaling operation is configured to stretch and/or compress the received frames of the audio input signal.

14. A method for time scaling audio signals, the method comprising:
receiving an audio input signal comprising one or more frames;
applying a distortion criterion to the received frames of the audio input signal in order to generate a control signal representative of whether or not the received frames satisfy the distortion criterion, the distortion criterion associated with a time scaling operation;
performing the time scaling operation on some or all of the received frames to produce corresponding time scaled frames; and
providing an audio output signal comprising the received frames or their corresponding time scaled frames in accordance with the control signal.

15. A computer program comprising computer code configured to perform the method of claim 14.
